(19) United States
(12) Patent Application Publication
(10) Pub. No.: US 2005/0212868 A1
(43) Pub. Date: Sep. 29, 2005

(54) Fluid-ejection device and methods of forming same

(76) Inventors: George Z. Radominski, Corvallis, OR (US); Steven D. Leith, Albany, OR (US); Timothy R. Emery, Corvallis, OR (US); Thomas H. Ottenheimer, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/810,270

(22) Filed: Mar. 26, 2004

(51) Int. Cl. B41J 2/045

(52) U.S. Cl. 347/72

(57) ABSTRACT

The described embodiments relate to fluid-ejection devices and methods of forming same. One exemplary embodiment includes a plurality of fluid drop generators and associated electrically conductive paths, and at least one electron beam generation assembly configured to selectively direct at least one electron beam at individual electrically conductive paths sufficiently to cause fluid to be ejected from an associated fluid drop generator.

### BACKGROUND

Drop-on-demand fluid-ejection devices can be utilized in many diverse applications such as printing and delivery of medicines. Another application can include dispensing liquid materials for bio-assays. Still another application can comprise printing electronic devices with the fluid-ejection device. Drop-on-demand fluid-ejection devices can comprise multiple fluid drop generators. Individual fluid drop generators can be selectively controlled to cause fluid drops to be ejected therefrom.

An important criterion for the operation of drop-on-demand fluid-ejection devices is printing speed. As such, it is often desired to increase printing speed of a drop-on demand fluid-ejection device.

The diversity of applications for which drop-on-demand fluid-ejection devices can be employed encourages designs which may be adaptable to various configurations and which may have a relatively low manufacturing cost.

### BRIEF DESCRIPTION OF THE DRAWINGS

The same components are used throughout the drawings to reference like features and components wherever feasible. Alphabetic suffixes are utilized to designate different embodiments.

FIG. 1 illustrates a diagrammatic representation of an exemplary fluid-ejection device in accordance with one embodiment.

FIG. 2 illustrates a cross-sectional diagrammatic representation of another exemplary fluid-ejection device in accordance with one embodiment.

FIGS. 2a-2c illustrate slightly enlarged view of a portion of the embodiment of the fluid-ejection device as indicated in FIG. 2.

FIG. 3 illustrates a diagrammatic representation of a cross-sectional view of another exemplary fluid-ejection device in accordance with one embodiment.

FIGS. 3a-3b illustrate diagrammatic representations of cross-sectional views of a portion of an embodiment of the exemplary fluid-ejection device as indicated in FIG. 3.

FIGS. 3c-3d illustrate diagrammatic representations of cross-sectional views of a portion of an exemplary electron beam shape as indicated in FIG. 3b.

FIGS. 4a-4b illustrate diagrammatic representations of cross-sectional views of exemplary fluid-ejection devices in accordance with one embodiment.

FIG. 5 illustrates a diagrammatic representation of a cross-sectional view of a portion of another exemplary fluid-ejection device in accordance with one embodiment.

FIGS. 5a-5d illustrate one exemplary fluid ejection process from an exemplary fluid-ejection device in accordance with one embodiment.

FIGS. 5e-5f illustrate diagrammatic representations of cross-sectional view of a portion of another exemplary fluid-ejection device in accordance with one embodiment.

FIGS. 5g-5k illustrate diagrammatic representations of cross-sectional view of a portion of another exemplary fluid-ejection device in accordance with one embodiment.

FIGS. 6a-6r illustrate diagrammatic representations of process steps for forming a portion of an exemplary fluid-ejection device in accordance with one embodiment.

FIGS. 7, 8, and 9a-9b illustrate exemplary fluid ejection devices in accordance with one embodiment.

### DETAILED DESCRIPTION

Exemplary fluid-ejection devices are described below. In some embodiments the fluid-ejection devices generally comprise an electron beam generation assembly (generation assembly) interfaced with a fluid assembly. The fluid assembly can contain an array of fluid drop generators. In some embodiments individual fluid drop generators can comprise a microfluidic chamber (chamber), an associated nozzle and one or more displacement units. The generation assembly can supply electrical charges to effect individual displacement units enabling on-demand fluid drop ejection from the various fluid drop generators.

The embodiments described below pertain to methods and systems for forming fluid-ejection devices. The various components described below may not be illustrated to scale. Rather, the included figures are intended as diagrammatic representations to illustrate to the reader various inventive principles that are described herein.

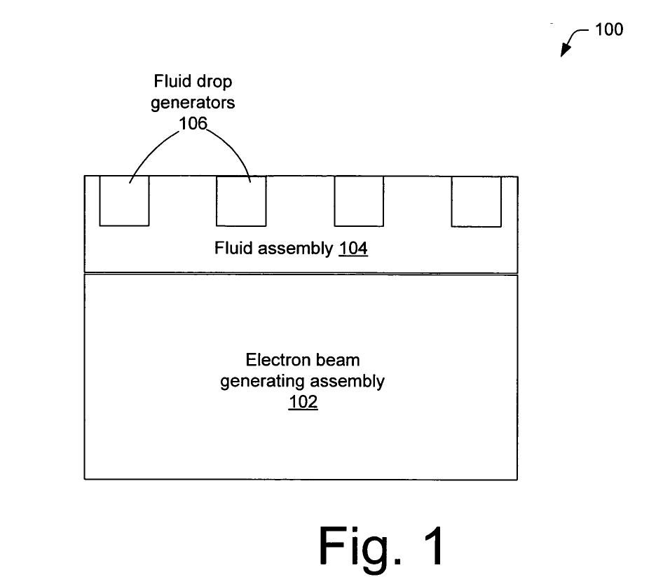

FIG. 1 illustrates a diagrammatic representation of an exemplary fluid-ejection device 100. In this particular embodiment fluid-ejection device 100 comprises a generation assembly 102 and a fluid assembly 104. Fluid assembly 104 can comprise a plurality of fluid drop generators 106. Generation assembly 102 can generate, during a predetermined time period, at least one electron beam for selectively controlling fluid ejection from individual fluid drop generators 106.

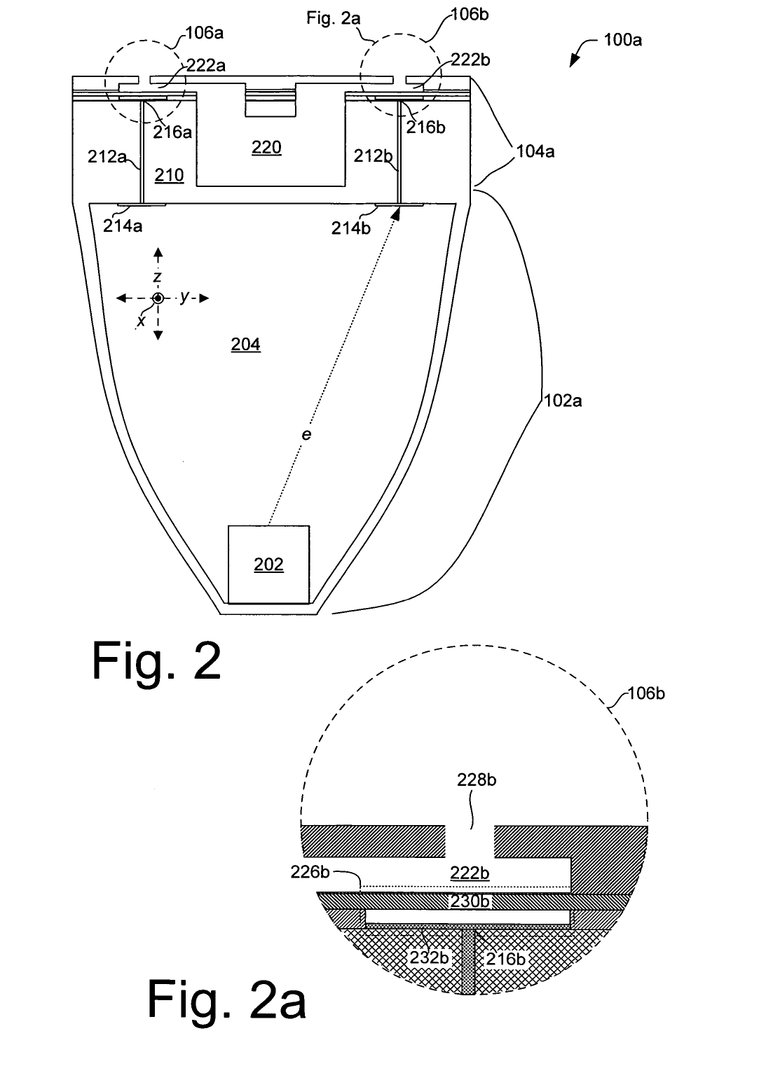

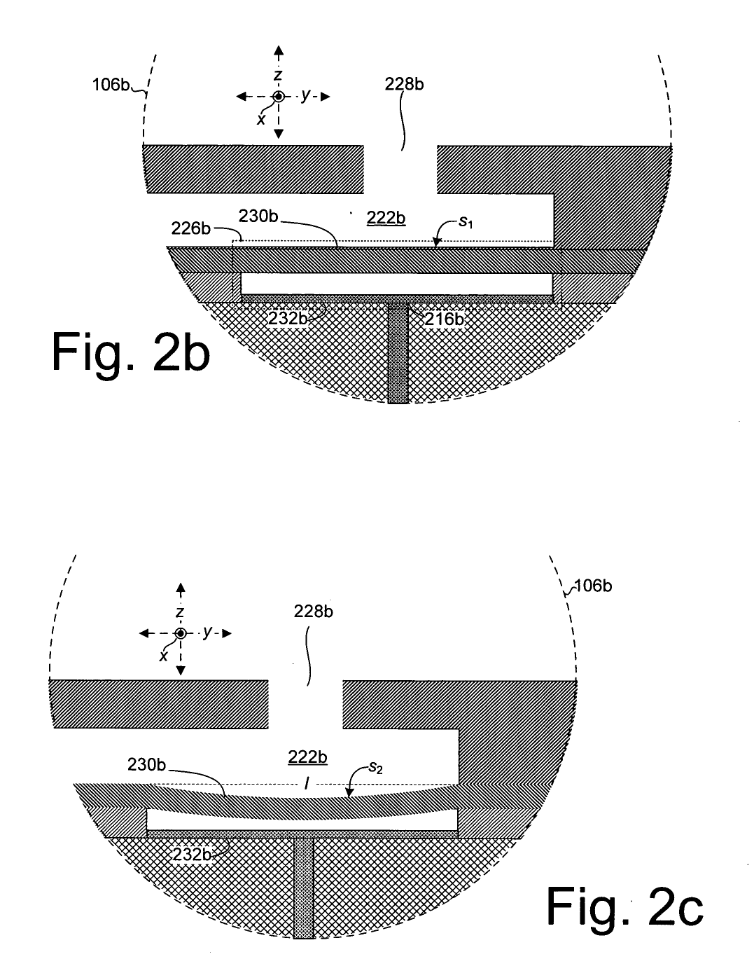

FIG. 2 illustrates a cross-sectional diagrammatic representation of another exemplary fluid-ejection device 100a having generation assembly 102a and fluid assembly 104a. FIG. 2a illustrates a slightly enlarged view of a portion of fluid-ejection device 100a as indicated in FIG. 2.

In some embodiments generation assembly 102a comprises one or more electron beam source(s) or electron guns 202. Other embodiments can employ one or more field emitters, which in one embodiment may be a source of electrons that relies on intense electric fields created by small dimensions to pull electrons from its surface. Some embodiments can utilize other types of electron sources. In this embodiment generation assembly 102a also comprises a vacuum tube 204 containing or otherwise associated with electron gun 202. Also in this embodiment vacuum tube 204 can be defined, at least in part, by a substrate 210 which also defines portions of fluid assembly 104a as will be described in more detail below. In this particular embodiment, electron gun 202 and vacuum tube 204 can comprise a cathode ray tube.

In this embodiment two electrically conductive paths 212a, 212b extend through substrate 210 between a first end 214a, 214b proximate vacuum tube 204 and a second end 216a, 216b proximate fluid drop generators 106a, 106b respectively. An individual conductive path such as conductive path 212b can receive electrical energy generated by electron gun 202 and deliver at least some of the energy proximate to fluid drop generator 106b. Fluid passageway 220 delivers fluid to chambers 222a, 222b for subsequent ejection. In this particular embodiment, electron gun 202, vacuum tube 204, substrate 210 and conductive paths 212a, 212b can comprise a cathode ray tube pin tube.

As can be appreciated from FIG. 2a, a displacement unit or structure indicated generally at 226b can displace fluid from chamber 222b resulting in fluid ejection from nozzle 228b. In this particular embodiment displacement unit 226b can comprise a displaceable assembly 230b positioned in proximity to a generally fixed assembly 232b. Displacement unit 226b can displace fluid through physical movement of one or more of its component parts which imparts mechanical energy to the fluid. As will be described in more detail below, such physical movement can be achieved in this embodiment via displaceable assembly 230b. Further, in some embodiments, displaceable assembly 230b can comprise an electrostatically deformable membrane as will be described in more detail below.

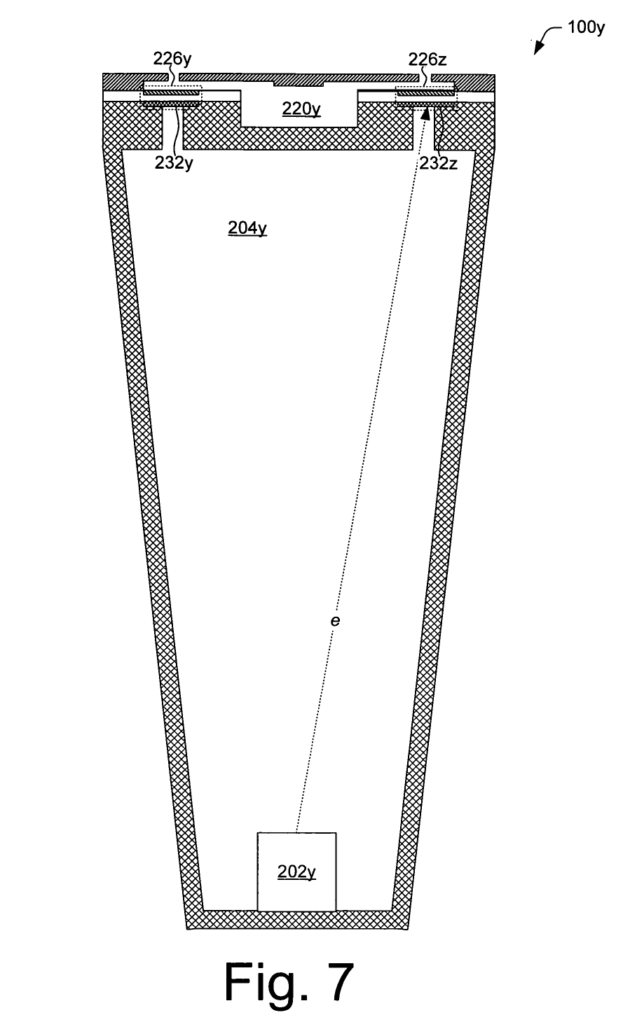

FIGS. 2b-2c illustrate further enlarged views of fluid drop generator 106b illustrated in FIG. 2a. FIGS. 2b-2c illustrate how one particular embodiment can eject fluid drops from fluid drop generator 106b. As illustrated in FIG. 2b displacement unit's displaceable assembly 230b is in a first position or state indicated generally as s₁. In this particular embodiment first state s₁ is a generally planar configuration which lies generally parallel to the xy-plane indicated in the drawing. Other embodiments can have other geometric configurations. One such example is provided below in relation to FIG. 7.

FIG. 2c illustrates displaceable assembly 230b where at least a portion is displaced from the first state or disposition s₁ (shown FIG. 2b) toward fixed assembly 232b to a second state or disposition s₂. A reference line l is added for purposes of explanation to illustrate z-direction displacement relative to the xy-plane. The magnitude of displacement relative to reference line l is for purposes of illustration and may not be accurately portrayed in FIG. 2c.

During operation generation assembly 102a can effect fluid ejection from the various fluid drop generators 106a, 106b. In this particular embodiment generation assembly 102a effects fluid ejection by addressing particular fluid drop generators to cause fluid to be ejected therefrom and by providing energy to drive the fluid ejection. For example, beginning with fluid drop generator's displaceable assembly 230b in the first state s₁ as illustrated in FIG. 2b, electron beam e can be steered so that it is directed at conductive path's first end 214b. The electron beam can produce a net negative charge in conductor's second end 216b which in this particular embodiment is electrically coupled to fixed assembly 232b. In this particular embodiment displaceable assembly 230b can have a relative positive charge and can be displaced toward fixed assembly 232b to the second state s₂ as illustrated in FIG. 2c. Directing electron beam e away from first end 214b causes the negative charge associated with fixed assembly 232b to dissipate and thus diminish the electrostatic attraction with displaceable assembly 230b. The displaceable assembly subsequently returns to its first state s₁ and can create mechanical energy on fluid within chamber 222b sufficient to eject a fluidic drop from nozzle 228b.

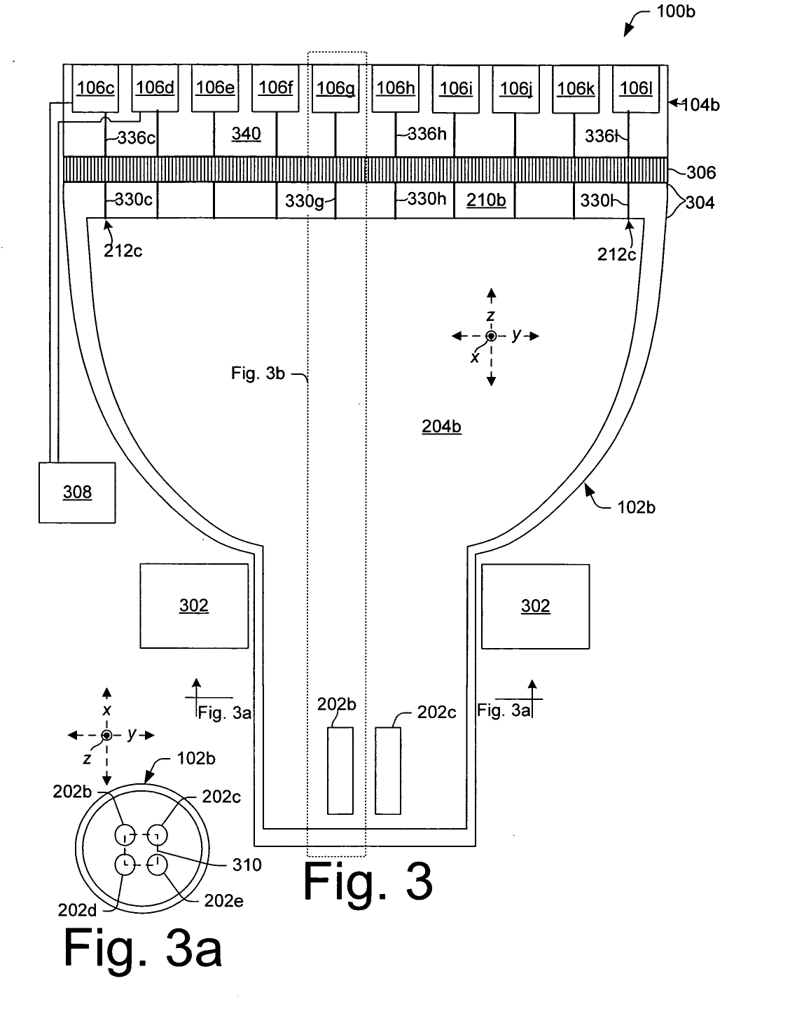

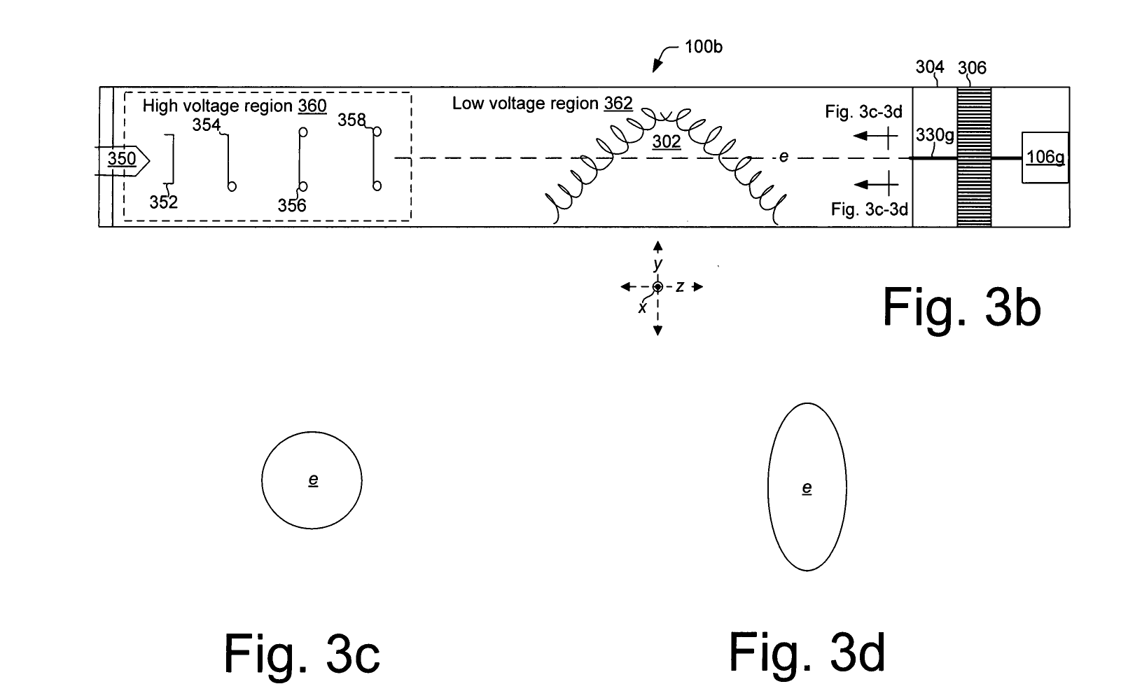

FIGS. 3-3e illustrate another exemplary fluid-ejection device 100b comprising generation assembly 102b and fluid assembly 104b. FIG. 3 illustrates a high level cross-sectional view taken generally along the yz-plane. FIG. 3a illustrates a cross-sectional view of a portion of fluid-ejection device 100b as indicated in FIG. 3. FIG. 3b illustrates a portion of fluid-ejection device 100b as indicated in FIG. 3. FIGS. 3c-3d illustrate cross-sectional representations of an exemplary electron beam configuration as indicated in FIG. 3b.

As can be appreciated from FIGS. 3-3a, in this embodiment generation assembly 102b has four electron guns 202b-e positioned within vacuum tube 204b. Electron guns 202b-202e can be configured to direct electron beams toward substrate 210b via a beam deflection means or deflection mechanism 302. In this particular embodiment deflection mechanism 302 can comprise a yoke. Other suitable embodiments may alternatively or additionally comprise deflection plates among others. Deflection mechanism 302 can achieve its functionality through various mechanisms including but not limited to electromagnetic and/or electrostatic deflection.

In this embodiment substrate 210b can define, at least in part, a pin or conductor plate 304. Positioned between pin plate 304 and fluid assembly 104b is an interface 306 which can allow generation assembly 102b to be coupled to fluid assembly 104b.

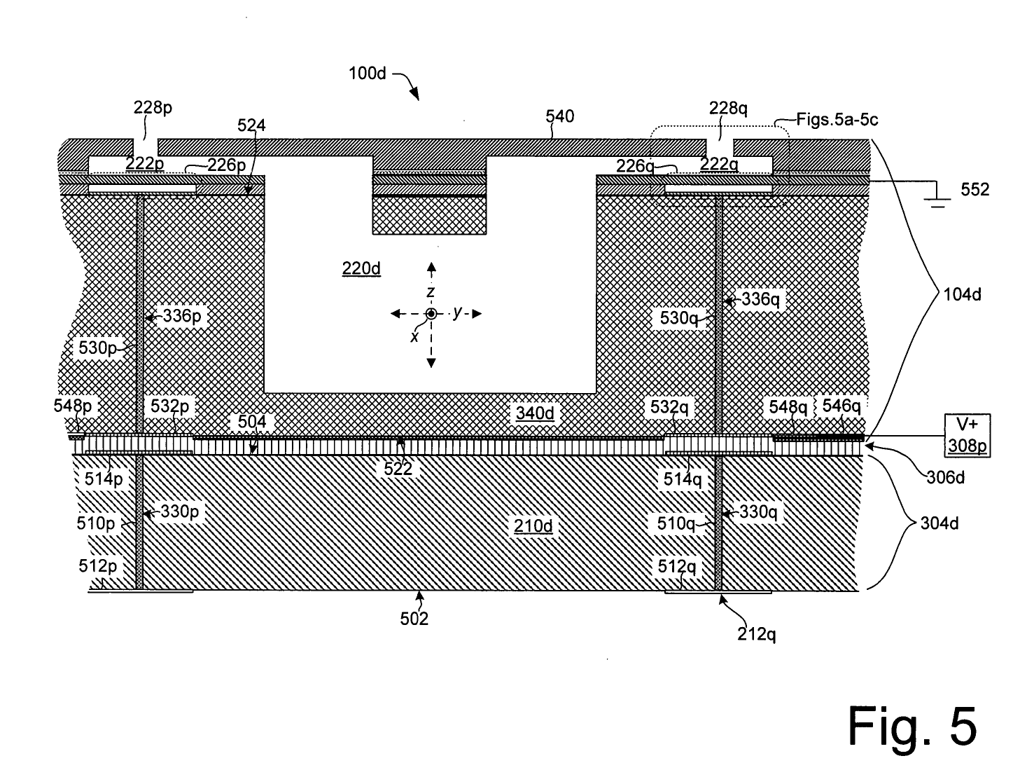

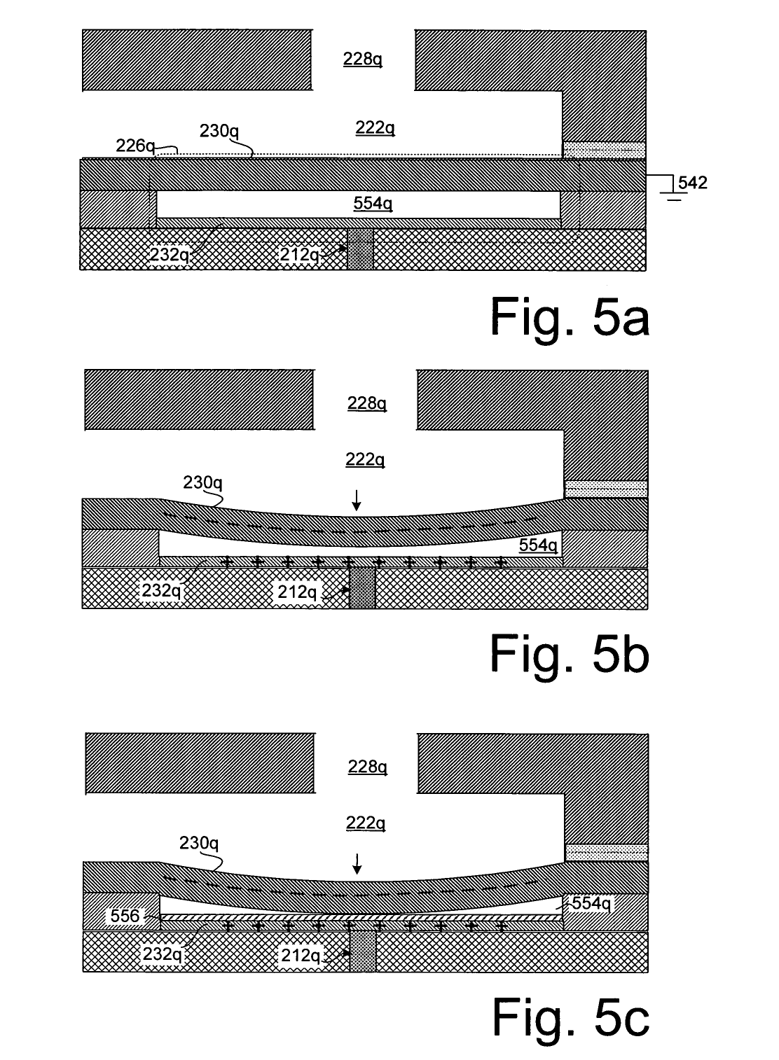

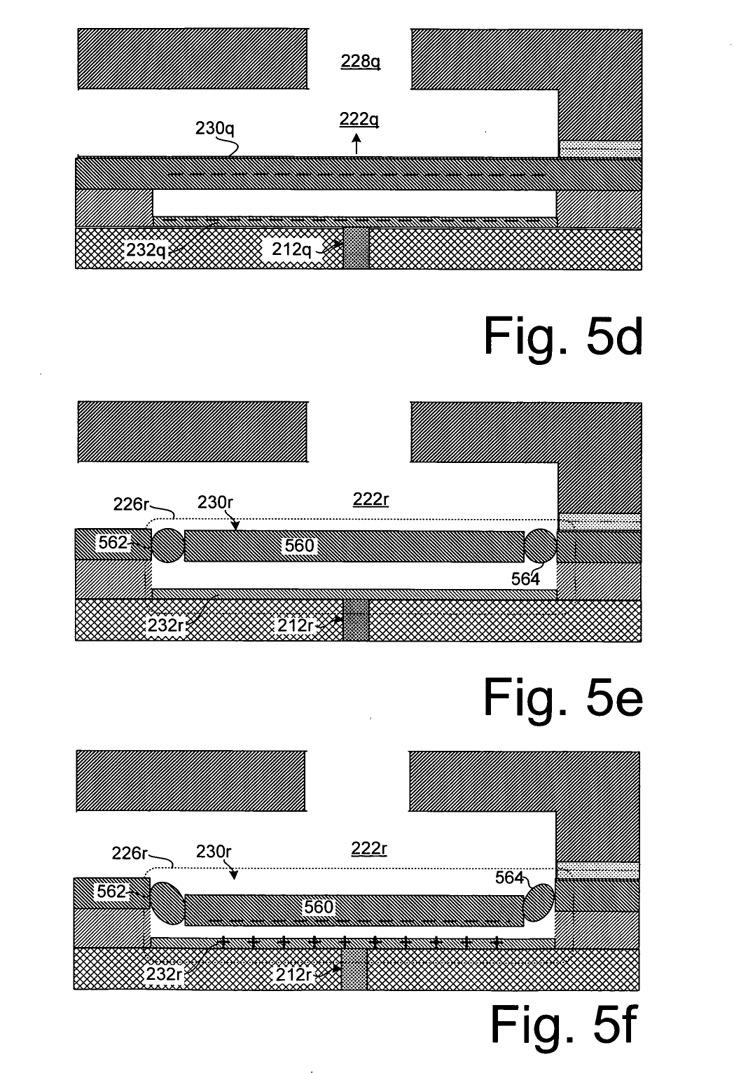

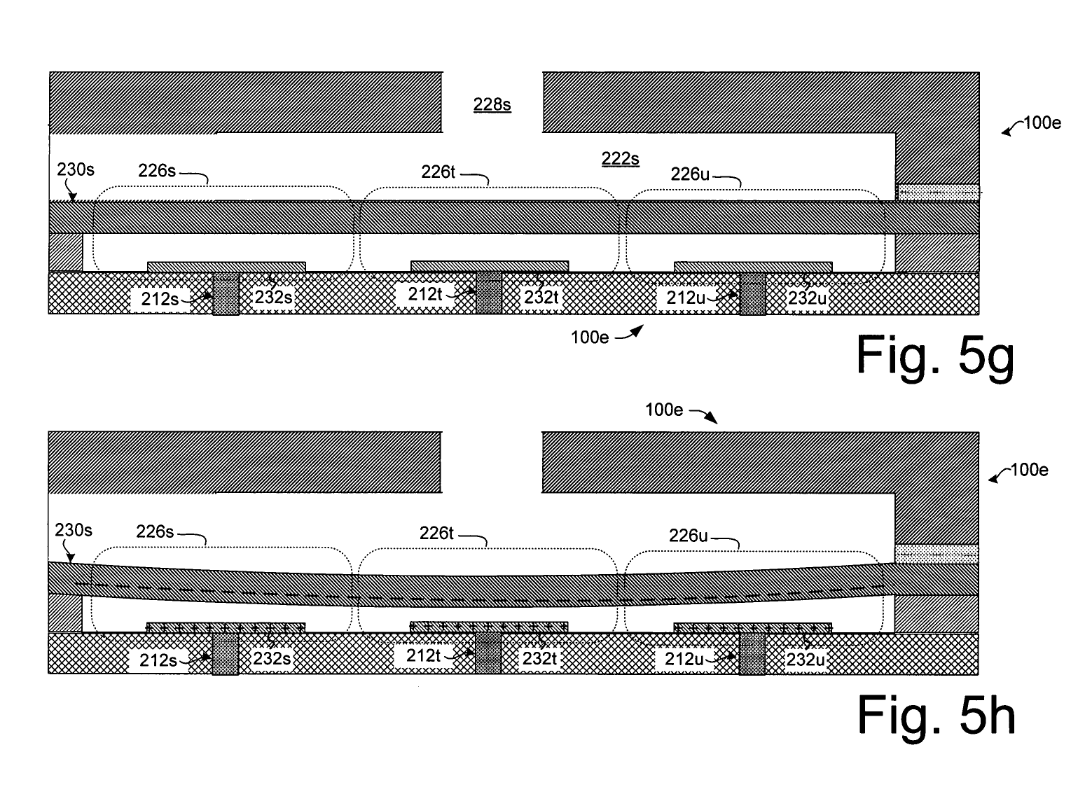

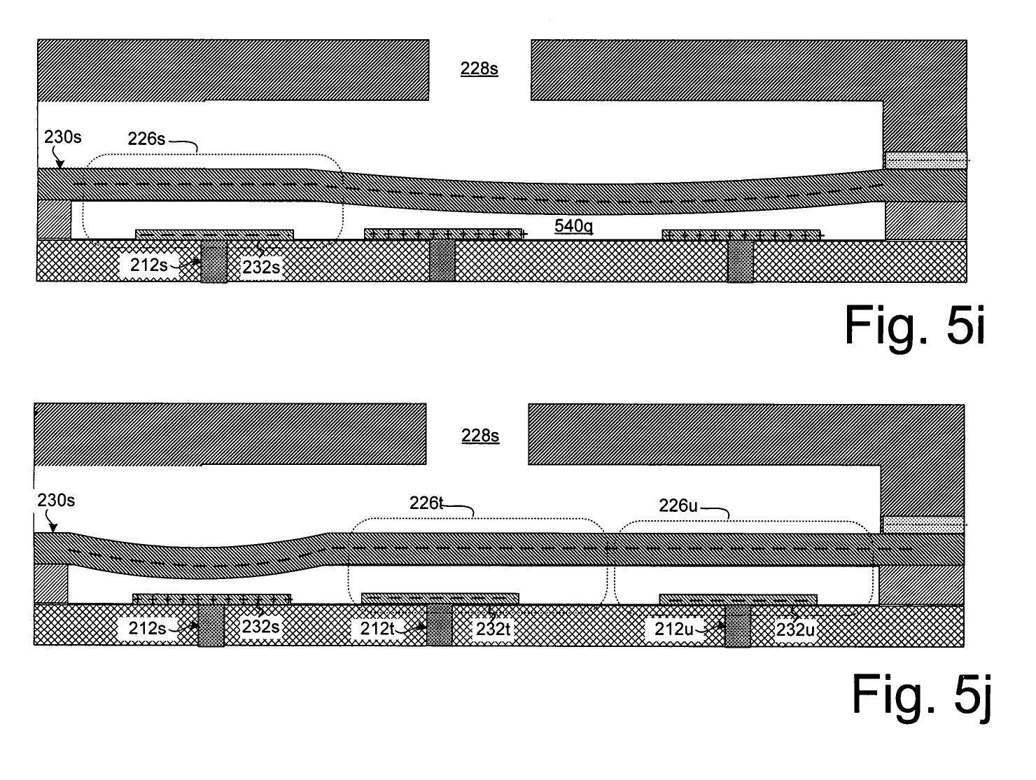

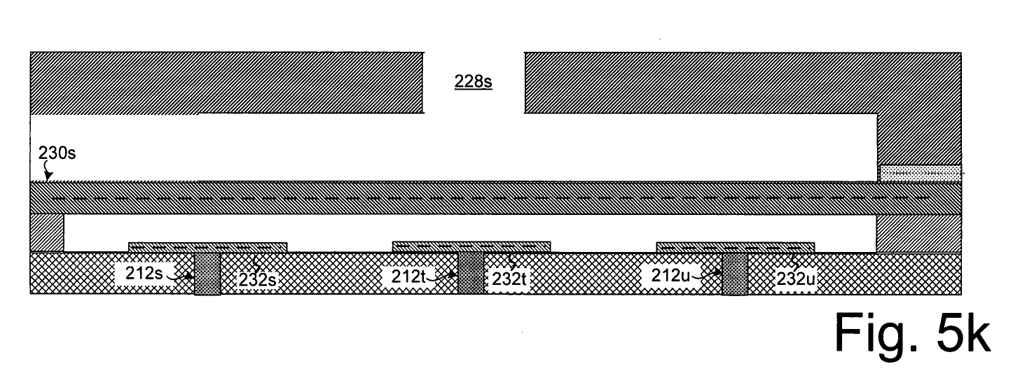

Function of the fluid assembly's fluid drop generators 106c-106l can be effected by a first signal generating means and a second signal generating means. In this embodiment the first signal generating means can comprise a voltage source 308 which is electrically coupled to individual fluid drop generators. Also in this embodiment the second signal generating means can comprise generation assembly 102b. Examples of these two signal generating means will be described in more detail below in relation to FIGS. 5-5k. Other embodiments may utilize other first and second signal generating means. Still other embodiments may utilize a single signal generating means to control an individual fluid drop generator. One such example is provided above in relation to FIGS. 2-2c.

In this embodiment generation assembly 102b and fluid assembly 104b can each comprise modular units. Such modularity can allow manufacturing and/or cost advantages. Further, such modularity can, in some embodiments, allow either the fluid assembly or the generation assembly to be replaced as an alternative to replacing the entire fluid-ejection device. For example some embodiments can removably assemble generation assembly 102b and fluid assembly 104b with the interface positioned therebetween. The fluid-ejection device can be disassembled to allow replacement of one or more of the generation assembly 102b, fluid assembly, 104b and interface 306.

As can be appreciated from FIG. 3a, in this particular embodiment the four electron guns 202b-202e are oriented to generally comprise four corners of a rectangle as indicated generally at 310. Other embodiments that employ multiple electron guns may utilize other configurations. In one such example multiple electron guns can be positioned in a generally linear fashion relative to one another. The positioning and location of electron guns 202b-202e are only constrained, in that, any electron beam generated by the electron guns is to be able to be directed to pin plate 304.

Multiple electrically conductive paths 212c-212l (not all of which are specifically designated) extend between pin plate 304 and individual fluid drop generators 106c-106l. In this embodiment at least a portion of electrically conductive paths 212c-212l can comprise conductors or pins 330c-330l (not all of which are specifically designated) extending through pin plate 304. In this embodiment conductors 330c-330l are positioned in generally electrically insulative or dielectric substrate material 210b which can electrically isolate individual conductors from one another. Examples of pin plate construction are provided below.

In this particular embodiment interface 306 is a generally compliant material, e.g. a rubber material, that in one embodiment is coated with a material making it generally electrically conductive along the z-axis and generally electrically insulative along the x and y-axes. Interface 306 can comprise a portion of the multiple electrically conductive paths 212c-212l and can allow electrical energy to flow from individual conductors 330c-330l of pin plate 304 into individual conductors or pins 336c-336l (not all of which are specifically designated) that supply individual fluid drop generators 106c-106l. Conductors 336c-336l can be formed in a substrate 340 of fluid assembly 104b.

In this particular embodiment fluid assembly 104b has an array of ten fluid drop generators 106c-106l generally arranged along the y-axis. The skilled artisan should recognize that other embodiments may have hundreds or thousands of fluid drop generators in an array. Similarly this cross-sectional view can represent one of many which can be taken along the x-axis to intercept different arrays. For example one embodiment can have 100 or more arrays arranged generally parallel to the x-axis with each array having 100 or more fluid drop generators arranged generally parallel to the y-axis. Some embodiments may also utilize a staggered or offset configuration of fluid drop generators relative to one or more axes. Such a staggered configuration may aid in achieving a desired fluid drop density in some embodiments.

FIG. 3b illustrates a portion of fluid-ejection device 100b as indicated in FIG. 3 in a little more detail. FIG. 3b illustrates components of individual electron guns utilized in this embodiment. Specifically FIG. 3b illustrates components of electron gun 202b. In this embodiment each of the electron guns has a similar configuration though such need not be the case. Electron gun 202b comprises a heater 350, a cathode 352, a grid 354, an anode 356, and a focus 358 which can be positioned in a high voltage region 360 of generation assembly 102b. Heater 350 can supply energy to excite cathode 352 sufficiently to emit electrons. Grid 354, anode 356, and focus 358 can shape and focus the electrons into a desired electron beam e as well as changing the number of electrons comprising electron beam e. The voltages utilized in this embodiment can be consistent with those known in the art. For example high voltage region 360 can be driven in some embodiments in a range of 5,000 volts to 20,000 volts. Other values may be utilized in some embodiments. The skilled artisan should recognize other electron gun configurations may be utilized with the embodiments described herein.

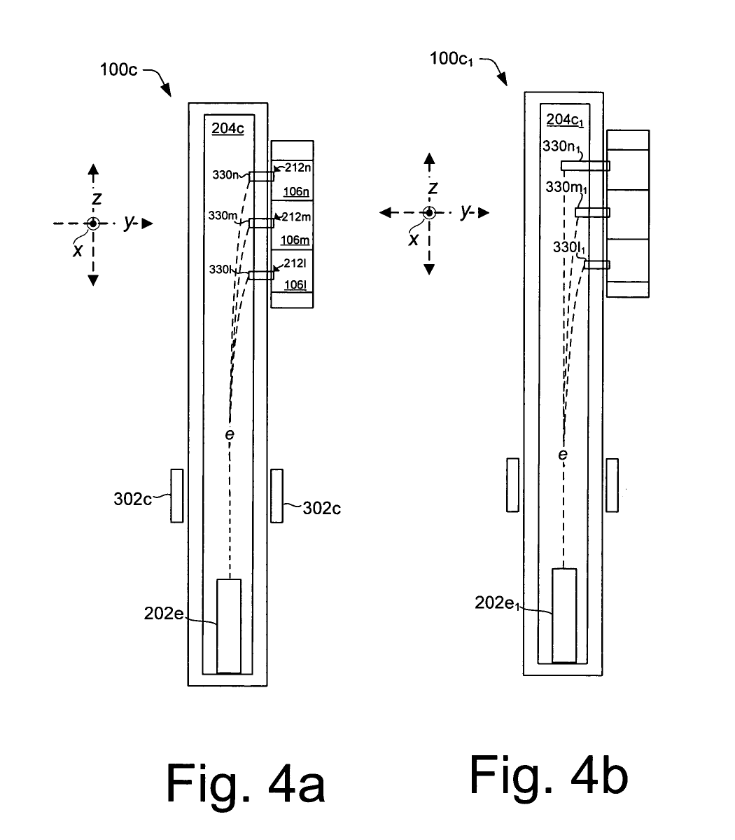

In this particular embodiment electron beam e is emitted from electron gun 202b parallel to the z-axis. Similarly, pin 330g extends generally parallel to the z-axis. In other embodiments such conductors may extend at obtuse angles relative to the electron beam. FIGS. 4a-4b illustrate embodiments where the conductors extend orthogonally to the axis of electron emission. The skilled artisan should recognize other electron gun configurations.

Examples of exemplary electron beam shapes are illustrated in FIGS. 3c-3d. Various exemplary embodiments can utilize electron beams having various cross-sectional dimensions and/or shapes. FIG. 3c illustrates a generally circular shape, while FIG. 3d illustrates a generally elliptical shape. Other exemplary shapes can include generally rectangular and square shapes among others. Beam size and shape can be adjusted, among other factors, to generally coincide with the cross-sectional shape and area of the pin plate's conductors 330c-330l.

In this particular embodiment deflection mechanism 302 is positioned proximate a low voltage region 362 of fluid-ejection device 100b. Deflection mechanism 302 can steer electron beam(s) e in the x and y-directions so that the beam e is directed at desired regions of pin plate 304. Beam current, as effected by the electron gun, can vary the energy imparted to an individual pin, such as 330g, in what is sometimes referred to as “z-axis modulation”. As will be discussed in more detail below, such energy variation may be utilized in some embodiments to effect a size of a fluid drop ejected from an individual fluid drop generator 106g associated with pin 330g. The skilled artisan should recognize that other embodiments may utilize deflection plates instead of or in combination with deflection mechanism 302.

In operation, an electron beam from electron guns 202b-202e can be stepped or scanned across the surface of pin plate 304 at high rates thereby maintaining fluid drop generators in a distended position. If the electron beam skips over a pin plate position during a scan or step operation, then that fluid ejection element is actuated to eject ink. Other operation scenarios relating to the interaction of the fluid ejection elements and the electron beams are described above and below.

FIGS. 4a-4b illustrate additional exemplary fluid-ejection device configurations. In the embodiment represented in FIG. 4a, fluid-ejection device 100c comprises vacuum tube 204c encompassing a single electron gun 202e, though multiple guns also can be utilized. Electron gun 202e is configured to generate one or more electron beams e which can be directed by deflection mechanism 302c toward conductors 330l-330n. Individual conductors 330l-330n can comprise at least a portion of electrically conductive paths 212l-212n respectively extending between vacuum tube 204c and individual fluid generators 106l-106n.

FIG. 4b illustrates still another exemplary fluid ejection device 100c₁. In this particular embodiment conductors 330l₁-330n₁ extend into vacuum tube 204c, non-uniform distances. In this particular configuration conductors protrude farther into the vacuum tube with increasing distance from electron gun 202c₁. Such a configuration can aid in directing electron beam e at a desired pin.

As can be appreciated from FIG. 4a, electron beam e can be emitted from electron gun 202e generally along the z-axis. Deflection mechanism 302c can bend or steer electron beam e along the y-axis toward individual conductors 106l-106n. Similarly, though not illustrated in this cross-sectional view electron beam e can alternatively or additionally be steered along the x-axis. The dotted lines representing electron beam e in FIG. 4a are intended to illustrate that the electron beam e can be steered to any one of the conductors rather than to indicate that the electron beam is being steered to all three conductors 106l-106n simultaneously. In this particular embodiment conductors 330l-330n generally extend parallel to the y-axis and electron beam e is emitted from electron gun 202e generally orthogonally to the y-axis. FIG. 3 above illustrates one example where the electrons are emitted generally parallel to an axis along which the conductors extend. The skilled artisan should recognize that other configurations may be utilized with the embodiments described herein.

FIGS. 5-5a illustrate cross-sectional representations of a portion of another exemplary fluid-ejection device 100d. As indicated in FIG. 5, FIG. 5a illustrates a portion of the fluid ejection device in a little more detail. In this embodiment pin plate 304d comprises a portion of a vacuum tube (not shown). Pin plate 304d comprises conductors 330p, 330q and electrically insulative substrate 210d. Conductors 330p, 330q extend between a first surface 502 of substrate 210d and a second substrate surface 504. Individual conductors have a central portion 510p, 510q extending between a first terminal portion 512p, 512q positioned proximate first surface 502 and a second terminal portion 514p, 514q positioned proximate second surface 504. In this particular embodiment the terminal portion may be enlarged to have greater surface area in the xy-plane. Such a configuration can allow easier alignment among various components among other attributes. When viewed generally along the z-axis first terminal portions 512p, 512q can be shaped and/or sized to generally coincide with the shape of the electron beam as discussed above in relation to FIGS. 3b-3d.

In this embodiment fluid assembly substrate 340d extends generally between first and second surfaces 522, 524. Individual conductors or conductors 336p, 336q of fluid assembly 104d have a central portion 530p, 530q extending through substrate 340d and between a first terminal portion 532p, 532q positioned proximate first surface 522 and a second terminal portion positioned proximate second surface 524. As noted above some embodiments may enlarge the terminal portions along the xy-plane for alignment and/or other purposes.

In this embodiment a single fluid channel 220d is configured to supply fluid to both chambers 222p, 222q. Fluid channel 220d can refill chambers 222p, 222q to replace fluid ejected through nozzles 228p, 228q respectively which are formed in orifice layer or orifice array 540. Other embodiments can have other supply configurations as should be recognized by the skilled artisan. Displacement units 226p, 226q can be positioned proximate chambers 222p, 222q.

Interface 306d can provide electrical coupling of the pin plate's individual conductors 330p, 330q to individual conductors 336p, 336q of fluid assembly 104d. Individual pin plate conductors 330p, 330q, fluid assembly conductors 336p, 336q, and an associated portion of interface 306d can comprise portions of electrically conductive paths. For example pin plate conductor 330q, interface 306d, and fluid assembly conductor 336q comprise at least a portion of electrically conductive paths indicated generally at 212q. These paths or pathways will be discussed in more detail below.

Voltage source 308p can be electrically connected to the displacement units 226p, 226q. In this particular embodiment voltage source 308p is connected to displacement unit 226q via conductive paths 212q. Specifically, in this particular embodiment voltage source 308q is electrically connected via conductor 546q to resistor 548q which is connected to electrically conductive path 212q. Electrically conductive path 212q is electrically connected to displacement unit 226q. Though not specifically shown voltage source 308p can be similarly electrically connected to displacement unit 226p.

In this particular embodiment resistors 548p, 548q are positioned on substrate 340d proximate interface 306d. Other suitable embodiments can position the resistors at other locations on the fluid-ejection device. For example, the resistors could be formed on the surface of substrate 340d proximate displacement units 226p, 226q or on either surface 502, 504 of pin plate 304d. Still other embodiments may utilize other configurations. For example in some embodiments conductors 546q and/or resistors 548p, 548q can be formed within substrate 340d. Alternatively or additionally to utilizing resistors 548p, 548q other exemplary embodiments can utilize various other passive or active (linear or non-linear) components. The skilled artisan should recognize such configurations.

As can be appreciated from FIG. 5a, displacement unit 226q, in this embodiment, can comprise displaceable assembly 230q and fixed assembly 232q. Further, in this embodiment displaceable assembly 230q is connected to an electrical ground indicated generally at 552. A dielectric region 554q can separate displaceable assembly 230q and fixed assembly 232q. In this particular embodiment dielectric region 554q can comprise air or other gases. Alternatively or additionally some embodiments may interpose an additional dielectric layer between displaceable assembly 230q and fixed assembly 232q. For example, the additional dielectric layer may be positioned on either or both of the opposing surfaces of displaceable assembly 230q and fixed assembly 232q. One such example is described below in relation to FIG. 5c. The skilled artisan should recognize other configurations that may be utilized with the embodiments described herein.

FIGS. 5a-5c, in combination with FIG. 5, illustrate an exemplary fluid ejection process from an exemplary fluid-ejection device 100d. In this embodiment displaceable assembly 230q can comprise a material such as a membrane that can be effected by a relative charge environment to which the material is exposed. As illustrated in FIG. 5a no substantial charge differential exists between displaceable assembly 230q and fixed assembly 232q.

Referring now to FIG. 5b, in combination with FIGS. 5-5a, activation of voltage source 544 sends a first signal to displacement unit 226q. This first signal can cause a relatively positive charge along electrically conductive path 212q and fixed unit 232q relative to a generally negative charge of displaceable assembly 230q. Displaceable assembly 230q can be attracted to and distend into dielectric region 554q toward fixed assembly 232q. As displaceable assembly 230q distends, fluid can be drawn into chamber 222q from fluid channel 220d.

FIG. 5c illustrates an alternative configuration where an additional dielectric layer is positioned interposed between displaceable assembly 230q and fixed assembly 232q on either of both of the opposing surfaces thereof. In this particular embodiment the additional dielectric layer, indicated generally at 560, is positioned over fixed assembly 232q. Such a configuration can allow displaceable assembly 230q to distend across dielectric region 554q and physically contact the fixed assembly's dielectric layer 558 without shorting. Such a configuration may allow some embodiments to achieve more uniform drop sizes among the respective fluid drop generators comprising an exemplary fluid ejection device. Such uniformity may be attributable, at least in part, to allowing displaceable assembly 230q to distend until it is physically blocked by the fixed assembly. Such a configuration can provide repeatability as it relates to a given displacement unit and/or between numerous displacement units.

Reference now to FIG. 5d in combination with FIG. 5 where an electron beam (not shown) can comprise a second signal which can be conveyed to displacement unit 226q. In this particular embodiment the electron beam can be directed at terminal portion 512q to impart a relatively negative charge along electrically conductive path 212q and ultimately fixed assembly 232q. As such, the attractive forces which distended displaceable assembly 230q toward fixed assembly 232q are reduced by the second signal and displaceable assembly 230q returns to its original state and as such can provide a mechanism for ejecting fluid from nozzle 228q. In this particular instance movement of displaceable assembly 230q can impart mechanical energy on fluid contained in chamber 222q. Though not specifically shown, in some embodiments the displaceable assembly may oscillate past the xy-plane generally before coming to rest as illustrated in FIG. 5c. When the electron beam is no longer acting upon conductive path 212q the relative charge configurations illustrated in FIG. 5b can be re-established and the displaceable assembly can return to the position illustrated in FIG. 5b or 5c.

For purposes of explanation displaceable assembly 230q is illustrated in a fully displaced condition in FIG. 5c and the displaceable assembly returns to a generally planar configuration illustrated in FIG. 5d when effected by an electron beam via conductive path 212q. Other embodiments may result in the displaceable assembly 230q assuming one or more intermediate positions by controlling the electrical charge imparted upon the path by an electron beam. For example an electron beam can act upon conductive path 212q sufficiently to cause the displaceable assembly to have a decreased attraction to fixed assembly 232q such that the assembly moves to a position intermediate to those represented in FIGS. 5c and 5d. As such a relatively small fluid drop may be ejected from nozzle 228q when compared to a drop size produced from the movement of the displaceable assembly from the position illustrated in FIG. 5c to that illustrated in FIG. 5d. Such charge variation can comprise an example of z-axis modulation as described above in relation to FIG. 3b for producing controllably variable fluid drop size.

FIGS. 5e-5f illustrate displacement unit 226r having another exemplary configuration. In this embodiment displaceable assembly 230r comprises a generally rigid material 560 which extends between two compliant structures 562, 564. In this particular embodiment rigid material 560 can be moved relative to fixed assembly 232r utilizing relative charge as described above to impart mechanical energy on fluid contained in chamber 222r.

FIGS. 5-5f illustrate embodiments having a single displacement unit associated with a chamber. FIGS. 5g-5k illustrate another exemplary configuration that may among other attributes produce controllably variable fluid drop size. The views illustrated in FIGS. 5g-5k are similar to those illustrated in FIGS. 5a-5f and represent a portion of fluid-ejection device 100e.

As illustrated in FIG. 5g, in this embodiment fluid-ejection device 100e has multiple independently controllable conductive paths associated with an individual chamber. In this particular embodiment three independently controllable conductive paths 212s-212u are coupled to fixed assemblies 232s-232u respectively. In this particular embodiment the three displacement units share a common displaceable assembly 230s. Other embodiments may have distinctly divided components. One, two or all three of the fixed assemblies 232s-232u can be selectively charged by an electron beam to effect portions of displaceable assembly 230s associated with the various displacement units 226s-226u.

FIG. 5h illustrates each of the three fixed assemblies 232s-232u having a relatively positive charge and negatively charged displaceable assembly 230s being displaced toward the fixed assemblies for each of the displacement units 226s-226u.

FIG. 5i illustrates an example where an electron beam has changed conductive path 212s and fixed assembly 232s from a generally positive charge to a generally negative charge. As a result, a portion of displaceable assembly 230s comprising displacement unit 226s has decreased attraction to the path and returns to a non-displaced configuration which can eject a fluid drop from nozzle 228s.

Similarly, FIG. 5j illustrates an example where an electron beam imparted a generally negative charge on fixed assemblies 232t, 232u. A second portion of displaceable assembly 230s associated with displacement units 226t, 226u returns to a non-displaced configuration which can cause a fluid drop to be ejected from nozzle 228s. In this instance the fluid drop may be larger than the fluid drop described in relation to FIG. 5i.

FIG. 5k shows still another possible example where an electron beam imparts a generally negative charge on each of the three conductive paths 212s-212u and associated fixed units 232s-232u. The negative charge decreases the attractive forces acting upon displaceable assembly 230s which returns to a non-displaced condition. As a result a fluid drop ejected from nozzle 228s may be larger than the fluid drops described in relation to FIGS. 5i-5j. The skilled artisan should recognize still other exemplary configurations.

FIGS. 5-5j are described in the context of an electron beam imparting a negative charge on conductive paths such as conductive path 212q illustrated in FIG. 5. However, the skilled artisan should recognize that other embodiments may be constructed to impart a positive charge on the conductive paths and to configure the fluid assembly accordingly. For example, a material, such as Magnesium oxide (MgO) can be positioned within the vacuum tube and over first terminal portion 512q such that an electron beam striking the material produces a secondary electron emission resulting in a net positive charge which is imparted along the path. Beam energy can be chosen to maximize secondary emission. As such, exemplary fluid-ejection devices can be configured which utilize the electron beam to impart either a relatively positive charge or a relatively negative charge on the paths to effect the displacement units. Alternatively or additionally to the example provided above, other materials may be utilized to optimize secondary emissions can comprise metals such as aluminum tantalum, nickel, iron, copper, chromium, zinc, silver, gold, and platinum among others. Other material can include metal alloys such as alloys of the metal listed above. Other materials can include metal oxides such as zinc oxide, tantalum oxide, and titanium oxide, among others. Still other materials can include ceramic materials such as alumina, ceria, silicon oxide, and silicon alloys such as silicon nitride and tungsten silicon nitride among others, and combinations of the above listed types of materials. The skilled artisan should recognize exemplary fluid-ejection devices which utilize each of these configurations.

The use of electron beam sources to actuate fluid ejection allows several advantages over known approaches. For example, electron beam sources can scan beams over the surface of plate 304 at rates approaching the gigahertz range. This may allow fluid ejection rates near the electron beam scan speeds.

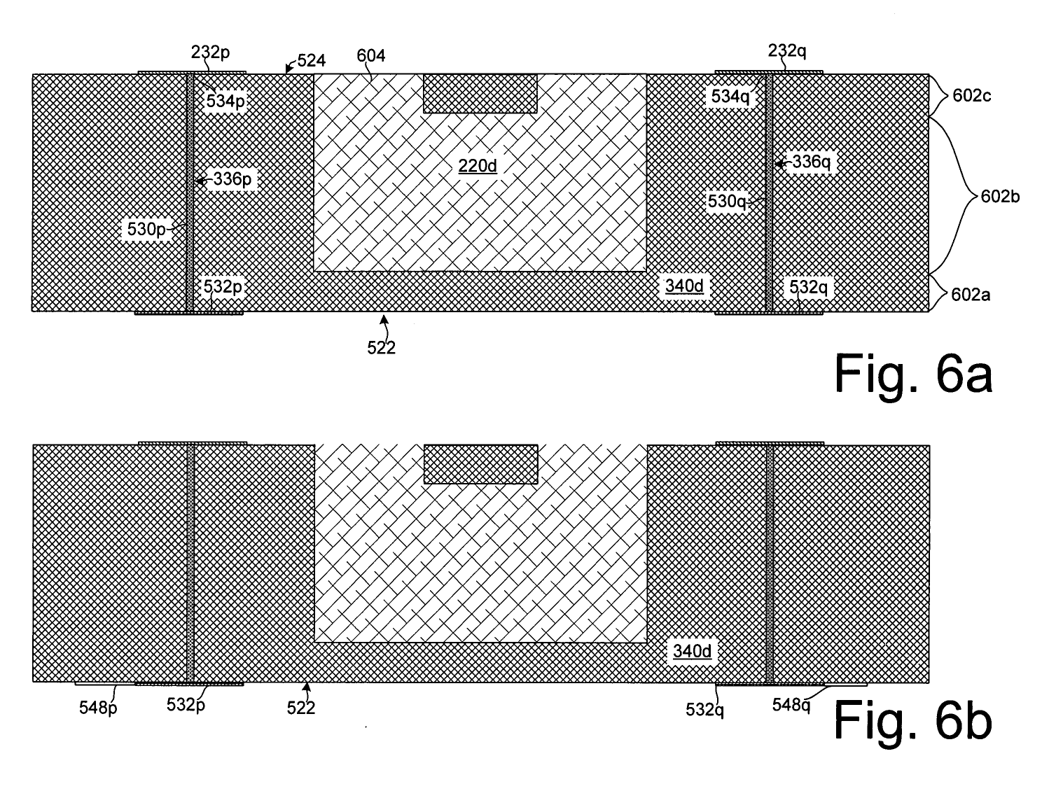

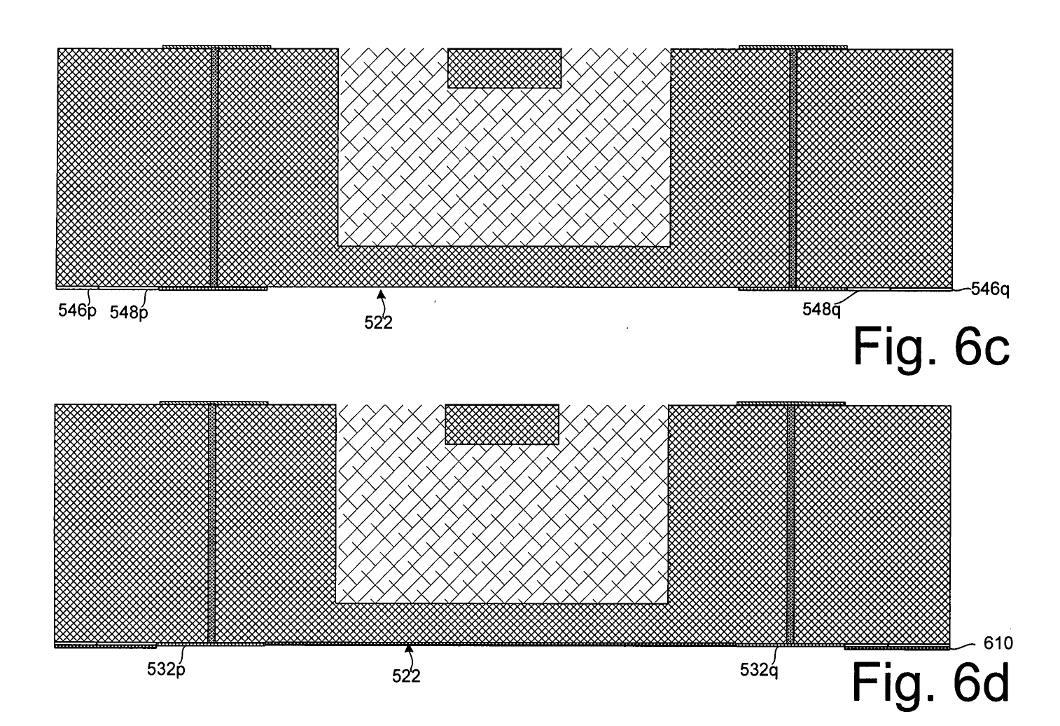

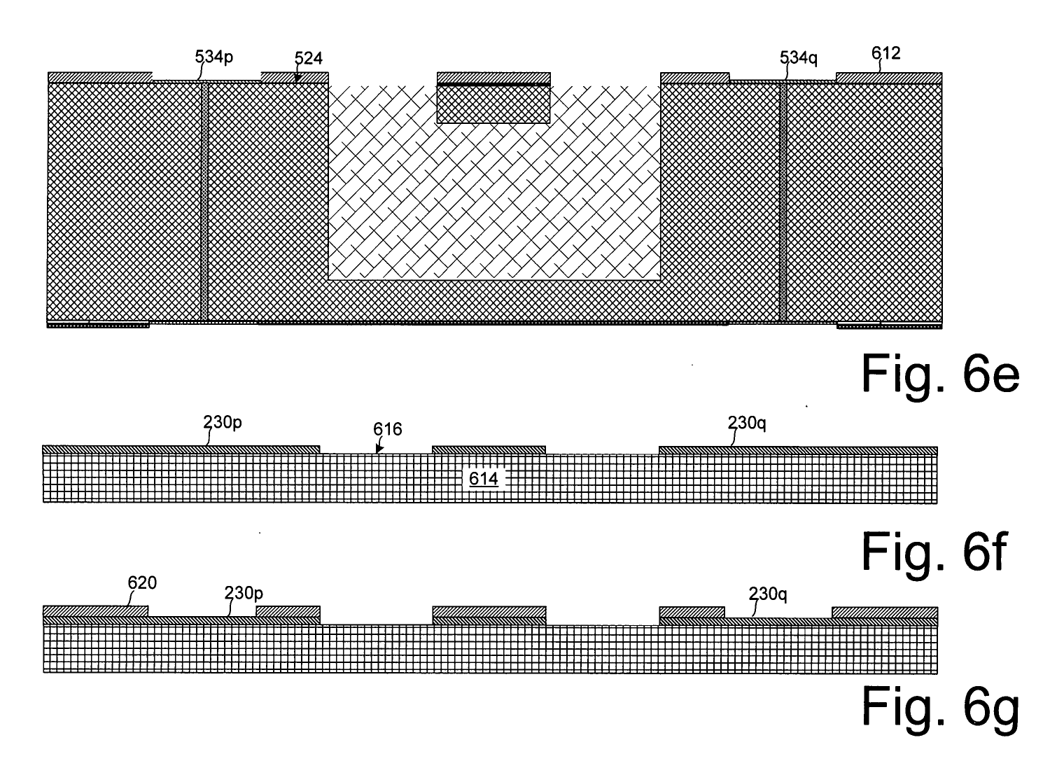

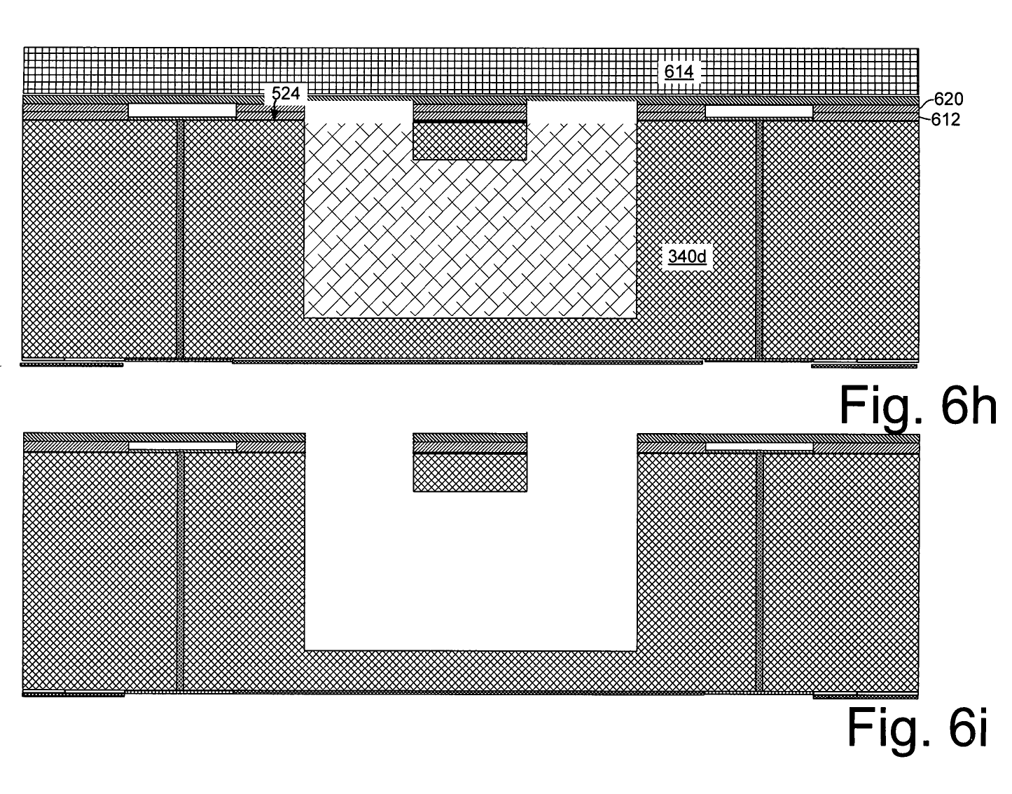

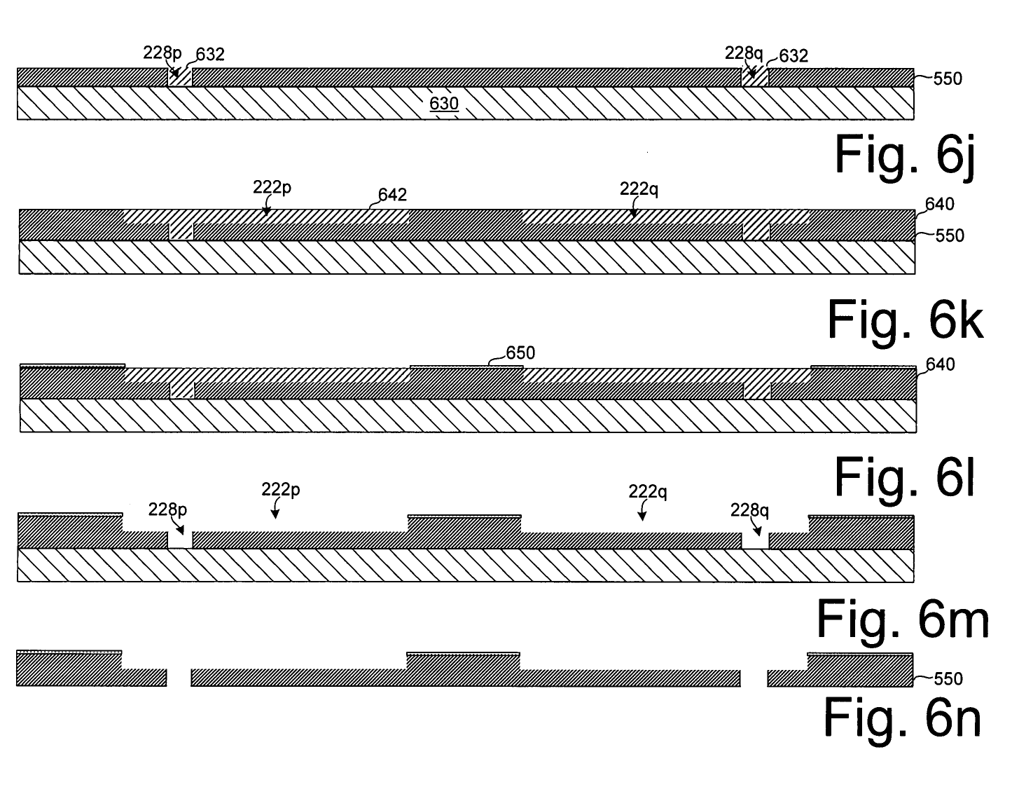

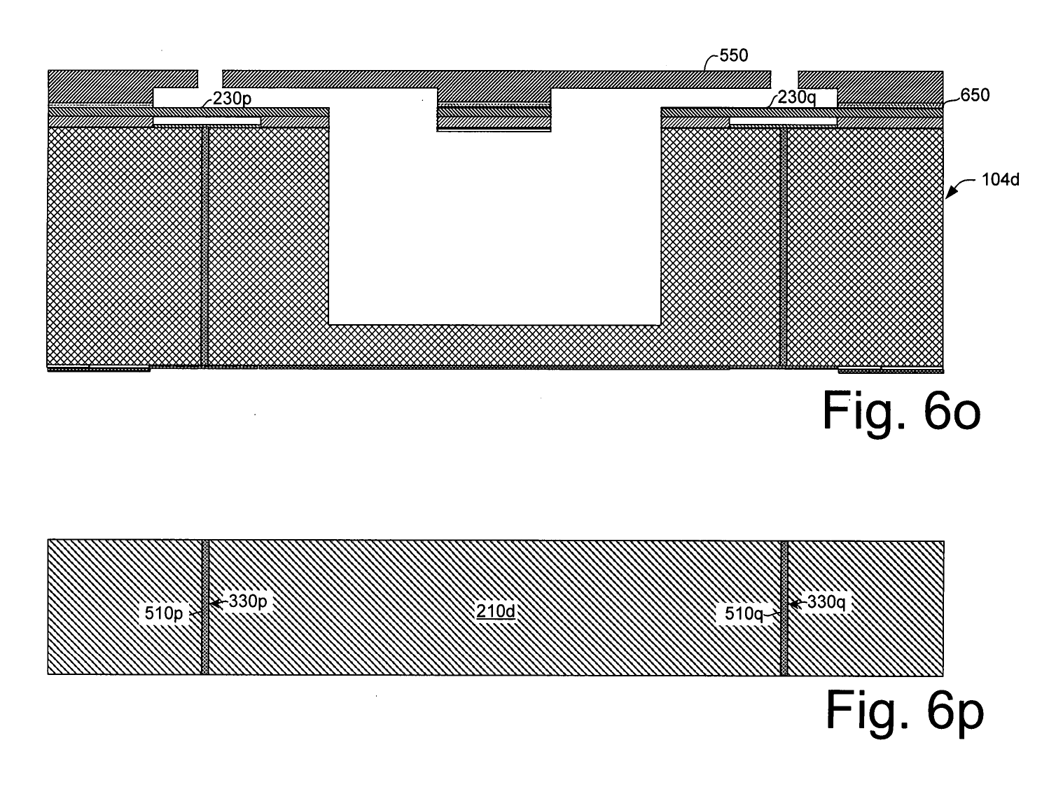

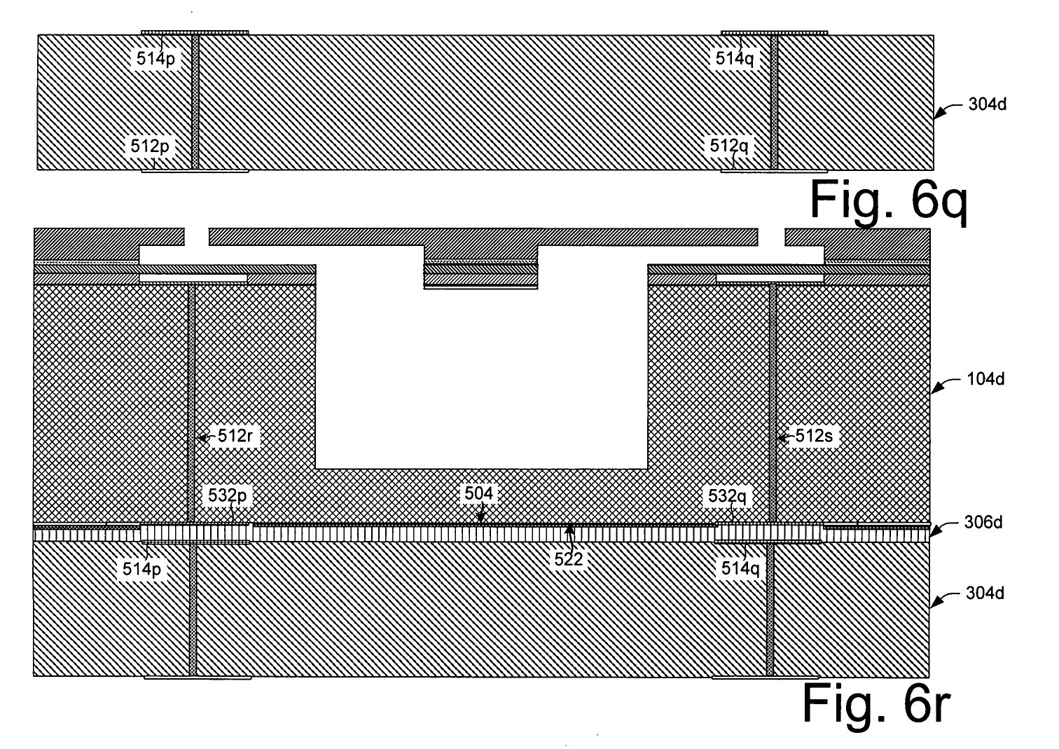

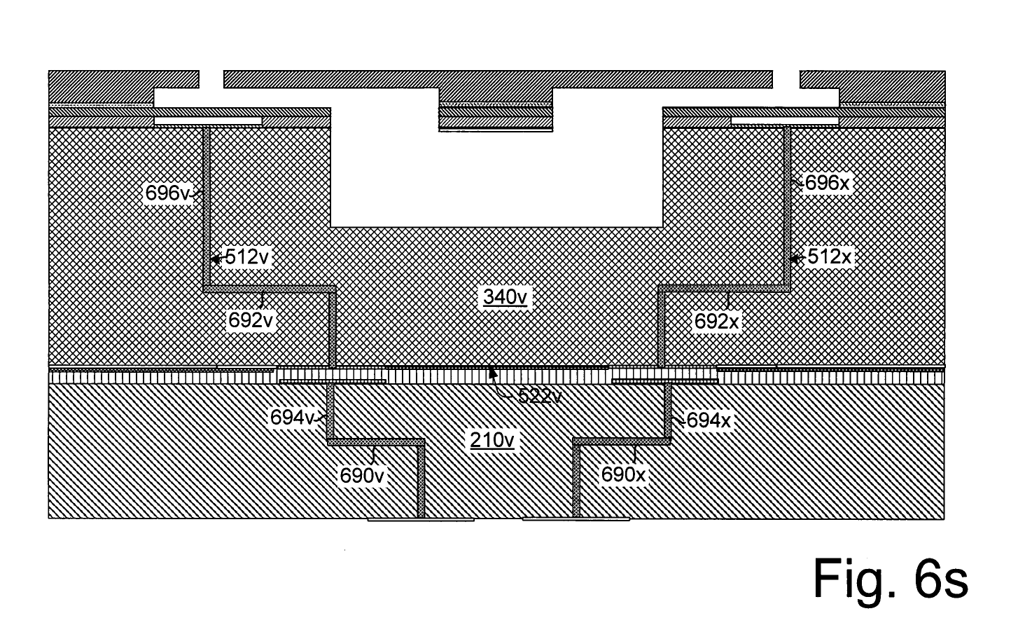

FIGS. 6a-6r illustrate process steps for forming a portion of an exemplary fluid-ejection device similar to that illustrated in FIG. 5. The skilled artisan should recognize other suitable processes.

Referring initially to FIG. 6a, a fluid channel 220d and conductors 336p, 336q are formed in substrate 340d. Substrate 340d can comprise any non-electrically conductive materials such as, but not limited to, ceramics such as silicate glass, quartz, and metal oxides, and plastics such as poly vinyl chloride and poly styrene.

In some formation processes substrate 340d can comprise multiple layers. For example a first layer 602a can be formed followed by a second layer 602b and then third layer 602c. In one particular formation process holes corresponding to central portion 530p, 530q of conductors 336p, 336q respectively are formed in first layer 602a comprised of green or unfired alumina. The holes can be filled with a conductive material such as nickel, copper, gold, silver, tungsten, carbon silicon and/or other conductive or semi-conductive materials or combinations thereof. In some embodiments the conductive material can comprise loosely associated particles such as a powder which is subsequently transformed into a solid component.

Referring again to FIG. 6a, where patterned second layer 602b comprising green alumina is positioned over first layer 602a. An area comprising fluid channel 220d is filled with one or more sacrificial fill materials 604 such as tungsten or other material. Holes corresponding to conductors' central portion 530p, 530q can be formed and filled as described above in relation to first layer 602a. Patterned third layer 602c comprising green alumina can then be positioned over second layer 602b. Holes corresponding to conductors' central portion 530p, 530q can be formed and filled as described above. The substrate then can be fired or heated which can harden the substrate material and/or the pin material. Firing or heating may also serve to bond the various layers such as 602a-602c to one another.

Terminal portions 532p-532q and 534p-534q and or fixed assemblies 232p, 232q can be formed on first and second surfaces 522, 524 respectively. Terminal portions 532p-532q and 534p-534q, and/or fixed assemblies 232p, 232q can comprise any suitable conducting or semiconducting material. Terminal portions 532p-532q and 534p-534q and/or fixed assemblies 232p, 232q can be formed before or after firing depending on the techniques employed. In one particular process terminal portions 532p-532q and 534p-534q fixed assemblies 232p, 232q can be photolithographically patterned utilizing known processes after firing.

Referring to FIG. 6b, resistors 548p, 548q are patterned over substrate's first surface 522 in electrical contact with terminal portion 532p, 532q respectively utilizing known processes. Resistor materials can include, but are not limited to, tungsten silicon nitride, doped or poly-silicon, tantalum metal and nitrides of silicon, titanium and/or boron.

Referring to FIG. 6c, conductors 546p, 546q are patterned over substrate's first surface 522 in electrical contact with resistors 548p, 548q. Known techniques such as a standard photolithography processes can be utilized to form the conductors.

Referring to FIG. 6d where an electrically isolative or insulative material 610 is patterned over substrate's first surface 522 leaving terminal portions 532p, 532q exposed. Electrically insulative materials can include silicon nitride or silicon carbide among others.

Referring to FIG. 6e where an electrically insulative or dielectric material 612 such as silicon dioxide is patterned over substrate's second surface 524 leaving fixed assemblies 232p, 232q exposed. Electrically insulative material 612 can be planarized to act as a spacer to maintain a desired distance between fixed assemblies 232p, 232q and a subsequent component as will become evident below.

Referring to FIG. 6f where another portion of an exemplary fluid ejection device is formed for subsequent assembly with the portion illustrated in FIG. 6e. Displaceable assembly 230p, 230q is positioned over at least a portion of a sacrificial carrier 614. In this process the displaceable assembly is formed over a surface 616 of carrier 614 and then patterned to form individual units such as displaceable assemblies 230p, 230q.

Referring to FIG. 6g where a dielectric or electrically insulative material 620 such as silicon dioxide is positioned over portions of displaceable assemblies 230p, 230q.

Referring to FIG. 6h where sacrificial carrier 614 is positioned over substrate's second surface 524. In one particular process dielectric material 612 is positioned against dielectric material 620 and the components can be exposed to conditions sufficient to bond the two dielectric layers. For purposes of illustration, FIG. 6h contains a line delineating dielectric material 612 from dielectric material 620, however, one homogenous material may be produced as a result of the bonding process.

Other embodiments may utilize other processes to form the displaceable assemblies over the substrate. In one such example a displaceable assembly may be laminated over substrate 340d with or without the aid of a sacrificial carrier.

Referring to FIG. 6i, sacrificial carrier 614 and sacrificial fill material 604 are removed utilizing known processes.

Referring to FIG. 6j nozzles are formed in orifice layer 540. Orifice layer 540 can be positioned on a mandrel 630 during formation of nozzles 228p, 228q. Orifice layer 540 can be formed from any suitable material utilizing known formation techniques. In this particular embodiment orifice layer 540 comprises a metal such as nickel. Other embodiments may utilize other metals or other material such as polymers. In some embodiments a sacrificial material 632 temporally can be positioned in the patterned areas during processing.

Referring to FIG. 6k, a chamber layer 640 is patterned over orifice layer 540 to form chambers 222p, 222q. Chamber layer 640 can comprise any suitable material such as various polymers. A sacrificial material 642 which may be the same material as sacrificial material 632 described above in reference to FIG. 6j can be positioned to temporally fill chambers 222p, 222q.

Referring to FIG. 6l, a bond layer 650 is patterned over chamber layer 640 utilizing known techniques.

Referring to FIG. 6m where sacrificial materials 632, 642 (illustrated in FIGS. 6j, 6k) can be removed utilizing known techniques from nozzles 228p, 228q and chamber 222p, 222q respectively.

Referring to FIG. 6n where mandrel 630 (illustrated in FIG. 6j) can be removed from orifice plate 550. Such removal can occur before or after positioning chamber layer 640 over substrate 340d as illustrated in FIG. 6o.

Referring to FIG. 6o where orifice layer 540 can be respectively positioned over displaceable assemblies 230p, 230q such that bond layer 650 bonds to portions of the displaceable assemblies to create a functional fluid assembly 104d.

Referring to FIG. 6p, central portions 510p, 510q of conductors 330p, 330q can be formed in substrate 210d in a manner similar to that described in relation to FIG. 6a.

Referring to FIG. 6q where terminal portions 512p, 512q and 514p, 514q are formed in a manner similar to that described above in relation to FIG. 6a. At least at this point in the processing, in some embodiments pin plate 304d may be incorporated as a portion of a vacuum tube in a known manner.

Referring now to FIG. 6r, pin plate 304d is positioned proximate fluid assembly 104d with interface 306d interposed therebetween. In this particular embodiment interface 306d comprises a deformable material which can serve to obviate any irregularities between pin plate's second surface 504 and fluid assemblies first surface 522. Example of deformable interface material can comprise anisotropically conductive polymer. One such example can comprise carbon fibers embedded in a silicone rubber matrix. Other deformable interface material can comprise other conductive polymeric materials such as metal wire embedded in rubber and metal particles embedded in epoxy resin, among other materials.

Other embodiments may utilize other interface materials. In one such example solder bumps can be positioned on one or both sets of terminal portions 514p, 514q and/or 532p, 532q. The pin plate 304d and the fluid assembly 104d can then be positioned proximate one another with the solder pads in a molten state until the solder resolidifies and can aid in maintaining the orientation and electrical connections therebetween. It should be noted that interface 306 is not needed and the conductors may run directly from the pin plate to ends 216 proximate displaceable assembly 226.

FIGS. 6a-6r illustrate process steps for forming an exemplary print head having conductive paths 512r, 512s which extend generally orthogonally to substrate's first surface 522. Other embodiments can have other configurations. For example, the conductive paths may have portions which are run parallel to the first surface of the fluid assembly's substrate. Alternatively or additionally, still other embodiments may have portions which run obliquely to the first surface. Such portion may occur in the pin plate substrate and/or the fluid-ejection substrate. One such example is described below in relation to FIG. 6s.

FIG. 6s illustrates an alternative embodiment where portions of the conductive paths 512v, 512x are generally parallel to first surface 522v while other different portions are oriented generally orthogonally to the first surface. In this particular configuration, conductor portions 690v, 690x and 692v, 692x are oriented generally parallel to first surface 522v while conductor portions 694v, 694x and 696v, 696x are oriented generally orthogonally to the first surface. The parallel portions can be formed utilizing the techniques described above where the substrates are formed in layers. Portions 690v, 690x, 692v, and 692x can be formed on a top surface of a first layer before positioning a second layer thereon. The portions can extend between the holes formed in the layers for the orthogonally oriented conductor portions as described above. The skilled artisan should recognize other exemplary configurations. For example, other embodiments may employ conductive paths having portions which are oblique relative to the first surface.

The embodiment illustrated in FIG. 6s can allow flexibility in the design layout of the various components comprising an exemplary fluid-ejection device. For example, such a configuration can allow greater conductor density in the fluid assembly or the pin plate as desired. Further, such a configuration can allow an evenly spaced array of conductors extending into the vacuum tube while allowing fluid drop generators to be arranged along fluid channels. Still other configurations should be recognized by the skilled artisan.

FIG. 7 illustrates another exemplary fluid ejection device 100y. In this particular embodiment fixed assemblies 232y, 232z of displacement units 226y, 226z can be formed into or over vacuum tube 204y. Vacuum tube 204y is configured to allow electron beam e to act directly upon displacement units 226y, 226z. In this particular embodiment the fixed assemblies overlay holes or gaps in the vacuum tube sufficient to allow electron beam e to act directly upon displacement units' fixed assemblies 232y, 232z. Here fixed assemblies 232y, 232z are formed from conductive materials and directing electron beam e at an individual fixed assembly can induce a charge thereon. Several examples of how such a configuration can be utilized to effect fluid drop ejection are described above. The skilled artisan should recognize many other exemplary configurations.

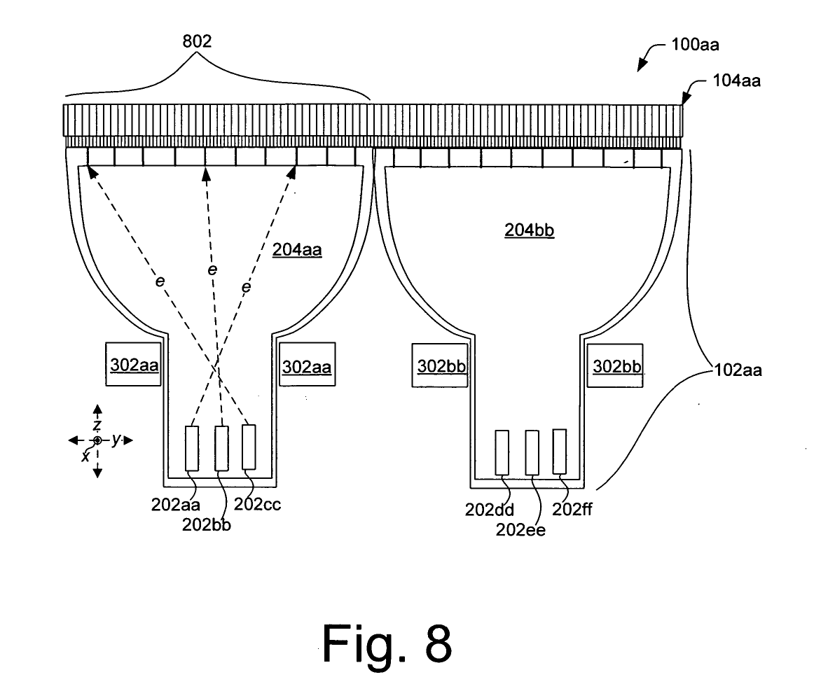

FIG. 8 illustrates still another exemplary fluid-ejection device 100aa comprising fluid assembly 104aa and generation assembly 102aa. In this embodiment generation assembly 102aa comprises two individual vacuum tubes 204aa, 204bb, associated electron guns 202aa-202cc and 202dd-202ff, and deflection mechanisms 302aa, 302bb. In this particular embodiment individual vacuum tubes and associated electron guns are configured to operate on a portion of the fluid assembly. For example, vacuum tube 204aa and associated electron guns 202aa-202cc are configured to operate on portion 802 of fluid assembly 104aa. The configuration illustrated in FIG. 8 can allow a single vacuum tube configuration to be manufactured in large quantities and associated with various sizes of fluid assemblies. For example, one embodiment may associate a generation assembly comprising a three by three array of the vacuum tubes illustrated in FIG. 8 with an appropriately sized fluid assembly to form a fluid-ejection device of a desired size.

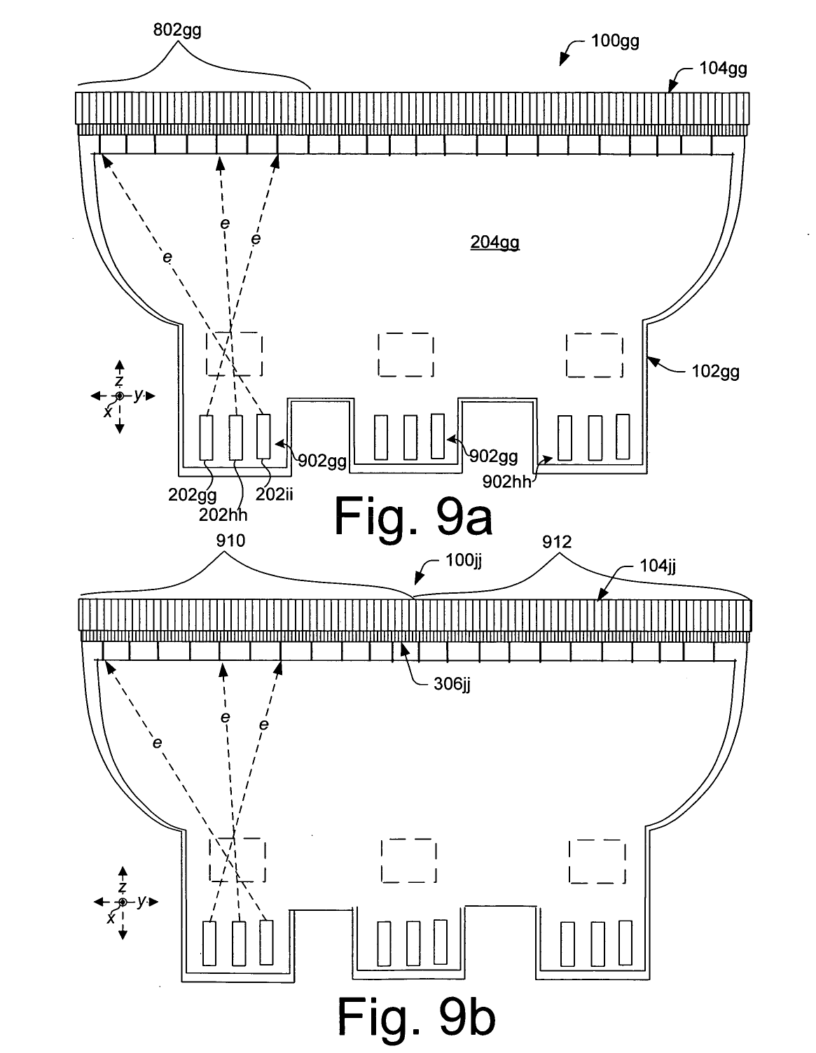

FIGS. 9a-9b illustrate additional exemplary fluid-ejection devices 100gg, 100jj. As illustrated in FIG. 9, generation assembly 102gg can comprise a single vacuum tube 204gg associated with two or more groups of electron guns. Each group of electron guns 902gg, 902hh and 902ii can comprise one or more electron guns. In this particular embodiment, individual groups of electron guns can comprise three electron guns. For example, group 902gg comprises electron guns 202gg-202ii. Individual groups of electron guns can be configured to operate on a portion of the fluid assembly. For example group 902gg can be configured to operate on portion 802gg. As illustrated in FIG. 9a, fluid assembly 104gg can comprise a single assembly of fluid drop generators. However, such need not be the case. As illustrated in FIG. 9b fluid assembly 104jj can comprise sub-assemblies of fluid drop generators associated to act as a single functional assembly. In this particular instance two sub-assemblies 910, 912 are illustrated. The sub-assemblies can be associated utilizing various suitable techniques. In this particular instance sub-assemblies 910, 912 can be associated, at least in part, by being bonded to interface 306jj. The skilled artisan should recognize still other exemplary configurations.

The described embodiments relate to fluid-ejection devices. The fluid-ejection device can comprise an electron beam generation assembly for effecting fluid ejection from individual fluid drop generators. In some of the embodiments the electron beam can cause a displacement unit to impart mechanical energy on fluid contained in the fluid drop generator sufficient to cause a fluid drop to be ejected from an associated nozzle.

It should be noted that while the application explains certain views of the figures in terms of the x, y, and z-axes, such description are not indicative of any specific geometery of the components described. Such x, y, and z-axes are merely described to facilitate an understanding of the location and position of components relative to one another in certain situations.

Although several embodiments are illustrated and described above, many other embodiments should also be recognized by the skilled artisan. For example, ‘front’ or ‘face’ shooter fluid assemblies are described above. The skilled artisan should recognize that many other embodiments can be configured utilizing ‘side’ or ‘edge’ shooter configurations. This provides just one example that although specific structural features and methodological steps are described, it is to be understood that the inventive concepts defined in the appended claims are not necessarily limited to the specific features or steps described. Rather, the specific features and steps are disclosed as forms of implementation of the inventive concepts.

1. A fluid-ejection device comprising:
at least one nozzle operatively associated with at least one displacement unit configured to impart mechanical energy on fluid associated with the nozzle to cause a fluid drop to be ejected from the nozzle; and,
a cathode ray tube configured to supply energy to selectively effect the displacement unit to control ejection of the fluid drop.

2. The fluid-ejection device of claim 1, wherein the cathode ray tube comprises a cathode ray pin tube having at least one conductor configured to receive an electron beam generated by the cathode ray tube, the at least one conductor being electrically coupled to an individual displacement unit via a conductive path.

3. The fluid-ejection device of claim 2, wherein the cathode ray pin tube is configured to emit an electron beam along a first axis and wherein the at least one conductor extends along a second axis which is generally orthogonal to the first axis.

4. The fluid-ejection device of claim 2, wherein the cathode ray pin tube is configured to emit an electron beam along a first axis and wherein conductor extends along a second axis which is generally parallel to the first axis.

5. The fluid-ejection device of claim 2, wherein the cathode ray pin tube is configured to emit an electron beam along a first axis and wherein conductive pin extends along a second axis which is generally obtuse to the first axis.

6. The fluid-ejection device of claim 1, wherein the at least one displacement unit comprises a fixed assembly and a displaceable assembly and wherein the displaceable assembly is configured to move relative to the fixed assembly to impart the mechanical energy on the liquid.

7. The fluid-ejection device of claim 1, wherein the at least one displacement unit comprises multiple independently controllable displacement units associated with the nozzle.

8. The fluid-ejection device of claim 1, wherein the displacement unit comprises a deformable membrane.

9. The fluid-ejection device of claim 1, wherein the at least one nozzle comprises a number of nozzles, and wherein the at least one displacement unit consists of a number of displacement units which equals a number of nozzles.

10. A fluid-ejection device comprising:
a plurality of fluid drop generators, individual fluid drop generators comprising a displaceable assembly for ejecting fluid; and,
an electron beam generation assembly configured to deliver electrical current proximate to individual fluid drop generators to cause fluid to be ejected therefrom.

11. The fluid-ejection device of claim 10, wherein the displaceable assembly is configured to have a non-displaced condition and a displaced condition and wherein delivering energy from the electron beam generation assembly proximate the displaceable assembly causes the displaceable assembly to assume the displaced condition.

12. The fluid-ejection device of claim 11, wherein the displaceable assembly is configured such that ceasing to deliver energy from the electron beam generation assembly proximate the displaceable assembly causes the displaceable assembly to assume the non-displaced condition which imparts mechanical energy upon fluid proximate the displaceable assembly.

13. The fluid-ejection device of claim 10 further comprising a voltage source configured to deliver electrical energy proximate the displaceable assembly sufficient to cause the displaceable assembly to assume a displaced condition and wherein delivering energy from the electron beam generation assembly proximate the displaceable assembly causes the displaceable assembly to assume the non-displaced condition and thereby exerting mechanical energy on fluid proximate the displaceable assembly sufficient to cause fluid to be ejected from an associated nozzle.

14. The fluid-ejection device of claim 10, wherein the displaceable assembly comprises a portion of a displacement unit and wherein the electron beam acts directly upon the displacement unit.

15. The fluid-ejection device of claim 10, wherein the electron beam generation assembly comprises a cathode ray tube having multiple conductors positioned therethrough which are independently addressable by an electron beam generated by the cathode ray tube.

16. The fluid-ejection device of claim 15, wherein the displaceable assembly comprises a portion of a displacement unit and wherein the electron beam generated by the electron beam generation assembly acts upon the displacement unit via one of the multiple conductors.

17. The fluid-ejection device of claim 15 further comprising an interface interposed between the cathode ray tube and the plurality of fluid drop generators and configured to electrically couple individual conductors of the cathode ray tube with individual fluid drop generators.

18. A fluid-ejection device comprising:
a fluid assembly defining a plurality of nozzles for ejecting fluid droplets; and,
a cathode ray pin tube associated with the fluid assembly and configured to selectively effect ejection of fluid droplets from individual nozzles.

19. The fluid-ejection device of claim 18, wherein the fluid assembly comprises a plurality of displacement units, individual displacement units associated with an individual nozzle and configured to impart mechanical energy on fluid proximate the displacement unit sufficient to cause fluid to be ejected from an individual nozzle.

20. The fluid-ejection device of claim 19, wherein the cathode ray pin tube comprises a plurality of electrically isolated conductors and wherein the fluid assembly comprises a plurality of conductors individually coupled to the displacement units and wherein individual conductors of the cathode ray pin tube are electrically coupled to individual conductors of the fluid assembly.

21. The fluid-ejection device of claim 18 further comprising an interface interposed between the fluid assembly and the cathode ray pin tube through which individual conductors of the fluid assembly are electrically coupled to individual conductors of the cathode ray pin tube.

22. The fluid-ejection device of claim 18, wherein the cathode ray pin tube is a modular unit and the fluid assembly is a modular unit and wherein the cathode ray pin tube assembly and the fluid assembly can be removably associated.

23. A fluid-ejection device comprising:
a fluid assembly comprising at least one displacement unit and an associated nozzle through which fluid can be selectively ejected; and,
at least one electron beam generation assembly configured to modulate and steer an electron beam to energize individual displacement units sufficient to cause a fluid drop to be ejected from the associated nozzle.

24. The fluid-ejection device of claim 23, wherein the electron beam generation assembly comprises deflection plates configured to steer the electron beam.

25. The fluid-ejection device of claim 23, wherein the electron beam generation assembly comprises a deflection mechanism configured to steer the electron beam.

26. The fluid-ejection device of claim 23, wherein the electron beam generation assembly is configured to control the current of the electron beam as a means to modulate the electron beam.

27. The fluid-ejection device of claim 23, wherein the electron beam generation assembly comprises a cathode ray pin tube.

28. The fluid-ejection device of claim 23, wherein the electron beam generation assembly comprises at least one field emitter.

29. A fluid-ejection device comprising:
a means for imparting mechanical energy on fluid contained in an associated chamber sufficient to cause fluid to be ejected from the chamber;
a first conductor configured to deliver a first signal to the means for imparting mechanical energy; and,
an electron beam source configured to deliver energy to the first conductor.

30. The fluid-ejection device of claim 29, wherein the means for imparting mechanical energy comprises a displaceable assembly and a fixed assembly.

31. The fluid-ejection device of claim 29, wherein the electron beam source is configured to deliver the energy independent of any fluid-ejection device integrated control circuitry.

32. The fluid-ejection device of claim 29, wherein the electron beam source comprises a cathode ray tube.

33. A fluid-ejection device comprising:
a plurality of chambers, individual chambers associated with a nozzle and a structure configured to move from a first position to a second position to cause fluid to be ejected from the nozzle;
a plurality of conductors, individual conductors being electrically coupled to individual structures; and,
an electron beam source configured to impart energy upon individual conductors to cause the structure to move from the first position to the second position.

34. The fluid-ejection device of claim 33, wherein the electron beam source is configured to emit an electron beam along a first axis and wherein the plurality of conductors extends along a second axis which is generally orthogonal to the first axis.

35. The fluid-ejection device of claim 33, wherein the electron beam source is configured to emit an electron beam along a first axis and wherein the plurality of conductors extends along a second axis which is generally parallel to the first axis.

36. The fluid-ejection device of claim 33, wherein the electron beam source is configured to emit an electron beam along a first axis and wherein the plurality of conductors extends along a second axis which is generally obtuse to the first axis.

37. The fluid-ejection device of claim 33, wherein the structure comprises a deformable membrane.
